(19) United States
(12) Patent Application Publication
(10) Pub. No.: US 2024/0140328 A1
(43) Pub. Date: May 2, 2024

(54) CONSOLE DEVICE FOR VEHICLE

(71) Applicant: SEOYON E-HWA CO., LTD., Anyang (KR)

(72) Inventor: Nakwon SUNG, Gimpo (KR)

(21) Appl. No.: 18/488,055

(22) Filed: Oct. 17, 2023

(30) Foreign Application Priority Data
Oct. 31, 2022 (KR) 10-2022-0143159

(51) Int. Cl. B60R 11/02; B60N 3/00; B60R 13/08

(52) U.S. Cl. CPC B60R 11/0235; B60N 3/001; B60R 13/0823; B60R 2011/0087

(57) ABSTRACT

A console device for vehicle is disclosed. The console device for vehicle according to an embodiment includes: a main body provided to one side of a seat; an accommodating groove depressed from the main body in an up-down direction, wherein an upper portion of the accommodating groove opens; and a convenient module configured to be liftable from the accommodating groove, wherein the convenient module includes: a partition configured to partition a space where the seat is positioned; at least one table connected to a front end of the partition; a display provided on a rear surface of the table; and a hinge connection portion rotatably supporting the table and the display with respect to the partition.

### CROSS-REFERENCE TO RELATED APPLICATION(S)

This application is based on and claims priority under 35 U.S.C. § 119 to Korean Patent Application No. 10-2022-0143159, filed on Oct. 31, 2022, in the Korean Intellectual Property Office, the disclosure of which is incorporated by reference herein in its entirety.

### BACKGROUND

### 1. Field

The disclosure relates to a console device for vehicle, and more particularly, a console device for vehicle capable of providing passengers' convenience and residential comfort by providing various convenient equipment according to the passengers' preferences.

### 2. Description of the Related Art

In general, a console for vehicle is positioned between seats arranged side by side to serve as an armrest on which passengers' arms are placed or as storage to store various things therein. However, using the console only for such purposes has the disadvantage of poor space utilization and poor usability because the console occupies a significant amount of volume in the interior space of the vehicle.

Moreover, recently, as the market for autonomous driving and mobility sharing services has grown rapidly, the development of Purpose-Based Vehicles (PBV), as means of transportation with a simple structure that focuses on the purpose of use of the vehicle, is being actively conducted. In particular, because autonomous driving purpose-based vehicles powered by electricity not only do not require space for engines and transmissions, but also do not require a driver's seat, the vehicles are being developed in a way that can transport people and objects efficiently. In these purpose-based vehicles, passengers often perform various activities, such as work, rest, and entertainment, inside the vehicle, and accordingly, devices that can provide various conveniences to passengers are required.

### SUMMARY

It is an embodiment of the disclosure to provide a console device for vehicle capable of providing various convenient equipment to passengers.

It is an embodiment of the disclosure to provide a console device for vehicle capable of improving a passenger's convenience and residential comfort.

It is an embodiment of the disclosure to provide a console device for vehicle capable of lowering manufacturing cost and improving productivity with a simple structure.

It is an embodiment of the disclosure to provide a console device for vehicle capable of making better use of an indoor space.

It is an embodiment of the disclosure to provide a console device for vehicle capable of easily storing and unfolding various convenient equipment.

Additional aspects of the disclosure will be set forth in part in the description which follows and, in part, will be obvious from the description, or may be learned by practice of the disclosure.

In accordance with an aspect of the disclosure, a console device for vehicle includes: a main body provided to one side of a seat; an accommodating groove depressed from the main body in an up-down direction, wherein an upper portion of the accommodating groove opens; and a convenient module configured to be liftable from the accommodating groove, wherein the convenient module includes: a partition configured to partition a space where the seat is positioned; at least one table connected to a front end of the partition; a display provided on a rear surface of the table; and a hinge connection portion rotatably supporting the table and the display with respect to the partition.

The convenient module may further include a rotation connection portion rotatably supporting the table and the display with respect to the hinge connection portion.

A rotation shaft of the hinge connection portion may extend in the up-down direction, and a rotation shaft of the rotation connection portion may extend in a horizontal direction.

A rotation shaft of the hinge connection portion may extend in the up-down direction, and the rotation connection portion may include a ball joint.

The partition may include a pocket portion depressed from the partition, and the table and the display may be rested on the pocket portion when being folded.

The convenient module may further include a module box accommodating a component therein, wherein an upper portion of the module box includes an opening, the module box being configured to be put in or taken out of the accommodating groove.

The convenient module may further include a door configured to open or close the opening.

The door may be rotatable with respect to the module box, and a rotation shaft of the door may extend in a front-rear direction.

The rotation shaft of the door may be elastically supported in a direction of closing the opening.

A pair of tables and a pair of displays may be provided, and a pair of hinge connection portions may be provided to rotatably support the pair of tables and the pair of displays independently with respect to the partition.

The accommodating groove may be formed in the main body and extend in a front-rear direction.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view showing a state in which a console device for vehicle according to an embodiment is installed in a vehicle;

FIG. 2 is a perspective view showing a console device for vehicle according to an embodiment in a state in which a convenient module is accommodated in the console device for vehicle;

FIG. 3 is a perspective view showing a console device for vehicle according to an embodiment in a state in which a partition of a convenient module is unfolded;

FIG. 4 is a perspective view showing a console device for vehicle according to an embodiment in a state in which a display of a convenient module is unfolded;

FIG. 5 is a perspective view showing a console device for vehicle according to an embodiment in a state in which a table of a convenient module is unfolded;

FIG. 6 is an enlarged view of an area A of FIG. 4; and

FIG. 7 is a cross-sectional perspective view of a convenient module according to an embodiment, showing an opening and a door for opening or closing the opening.

### DETAILED DESCRIPTION

Hereinafter, embodiments will be described in detail with reference to the accompanying drawings. The following embodiments are provided to transfer the technical concepts of the disclosure to one of ordinary skill in the technical art to which the disclosure belongs. However, the disclosure is not limited to these embodiments, and may be embodied in another form. In the drawings, parts that are irrelevant to the descriptions may be not shown in order to clarify the disclosure, and also, for easy understanding, the sizes of components are more or less exaggeratedly shown.

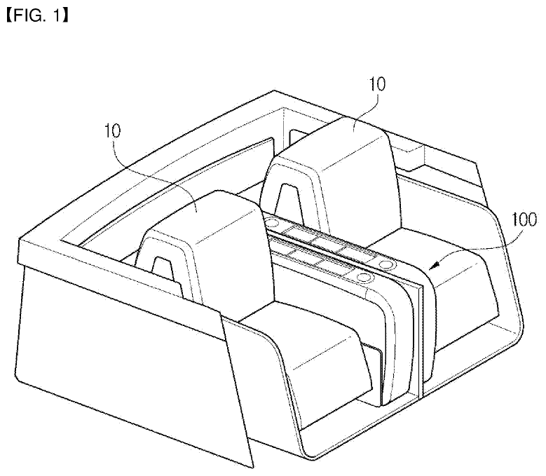

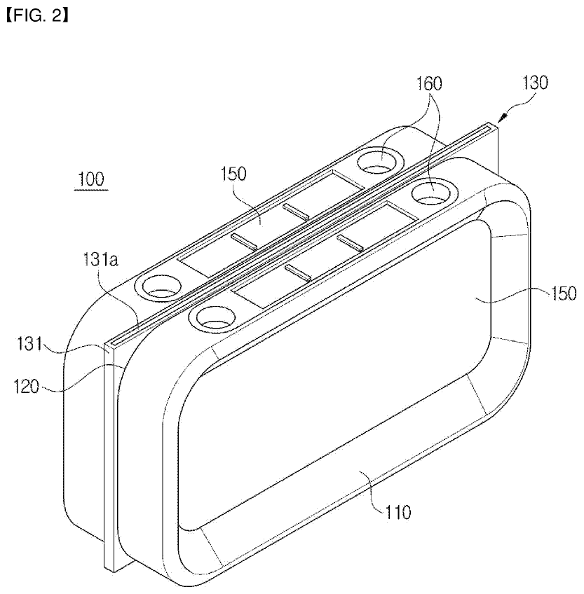

FIG. 1 is a perspective view showing a state in which a console device 100 for vehicle according to an embodiment is installed in a vehicle. Also, FIGS. 2 to 5 are perspective views showing the console device 100 for vehicle according to an embodiment.

Referring to FIGS. 1 to 5, the console device 100 for vehicle according to an embodiment may include a main body 110 positioned to one side of a seat 10, an accommodating groove 120 formed by being depressed from the main body 110, and a convenient module 130 configured to be liftable from the accommodating groove 120.

The main body 110 may be positioned between a pair of seats 10 arranged side by side. The main body 110 may be fixed to a bottom of an indoor space of the vehicle, or the main body 110 may be slidable in a front-rear direction of the vehicle according to a physique of a passenger seated on the seat 10. Because the main body 110 is provided between the pair of seats 10, the main body 110 may provide convenience to each of passengers seated on the pair of seats 10.

The main body 110 may be in a shape of a box, and an inlet and outlet of the accommodating groove 120 which will be described below may open in an upper portion of the main body 110 to put in or take out the convenient module 130 which will be described below. A cradle on which a passenger's goods are put, and a cup holder on which a glass, a bottle, etc. are put may be provided to both sides of the accommodating groove 120. The accommodating groove 120 may be formed by being depressed from the main body 110 in an up-down direction, and extend along a front-rear direction being a longitudinal direction of the vehicle.

The convenient module 130 may be liftable from the accommodating groove 120. The convenient module 130 may fall and be accommodated in the accommodating groove 120 to enable passengers seated on the pair of seats 10 to comfortably communicate with each other, or the convenient module 130 may be lifted and unfolded to provide convenience to the passengers seated on the seats 10.

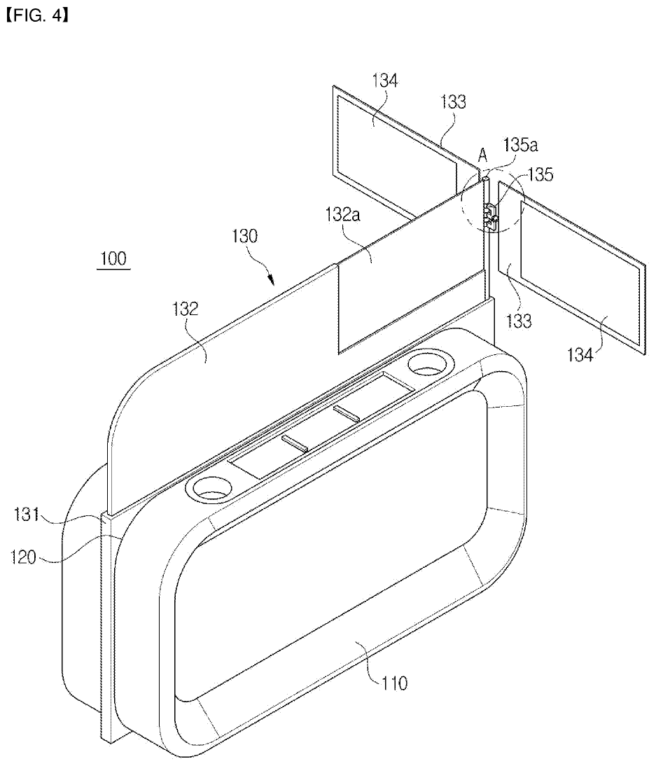

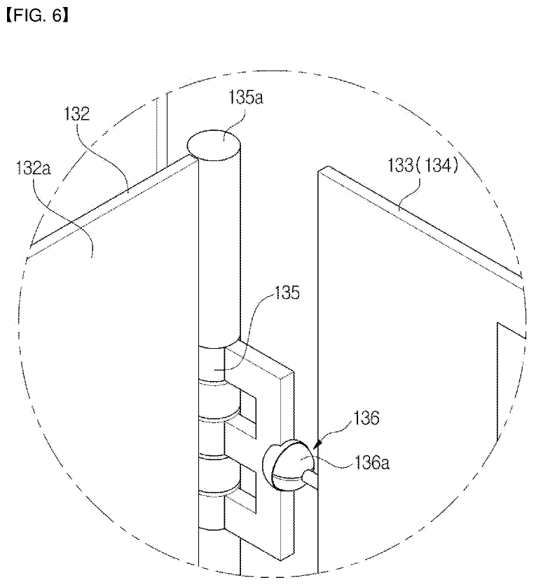

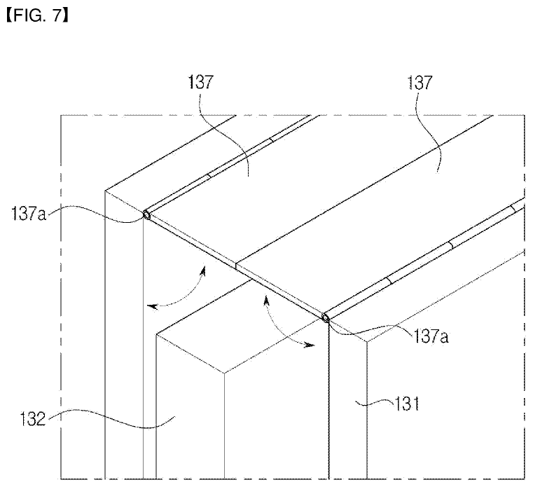

FIG. 6 is an enlarged view of an area A of FIG. 4, and FIG. 7 is a cross-sectional perspective view of the convenient module 130 according to an embodiment.

Referring to FIGS. 1 to 7, the convenient module 130 may include a partition 132 partitioning spaces where the seats 10 are positioned when the convenient module 130 is lifted and unfolded, a table 133 connected to the partition 132, a display 134 provided on a rear surface of the table 133, a hinge connection portion 135 supporting the table 133 and the display 134 in such a way as to be rotatable with respect to the partition 132, a rotation connection portion 136 supporting the table 133 and the display 134 in such a way as to be rotatable with respect to the hinge connection portion 135, a module box 131 in which components are accommodated, and a door 137 for opening or closing an opening 131a of the module box 131.

The module box 131 may accommodate various components, such as the partition 132, the table 133, the display 134, etc., therein, and the module box 131 may be put into or taken out of the accommodating groove 120. In an upper portion of the module box 131, the opening 131a from which the partition 132, the table 133, and the display 134 are unfolded to outside may open, and the opening 131a may extend in the front-rear direction. The opening 131a of the module box 131 may be opened or closed by a door 137. A pair of doors 137 may be respectively provided at both sides of the opening 131a, and a rotation shaft 137a of each door 137 may extend in the front-rear direction to open or close the opening 131a by rotating. In the rotation shaft 137a of the door 137, a spring (not shown) may be provided to elastically support the rotation shaft 137a in a direction of closing the opening 131a.

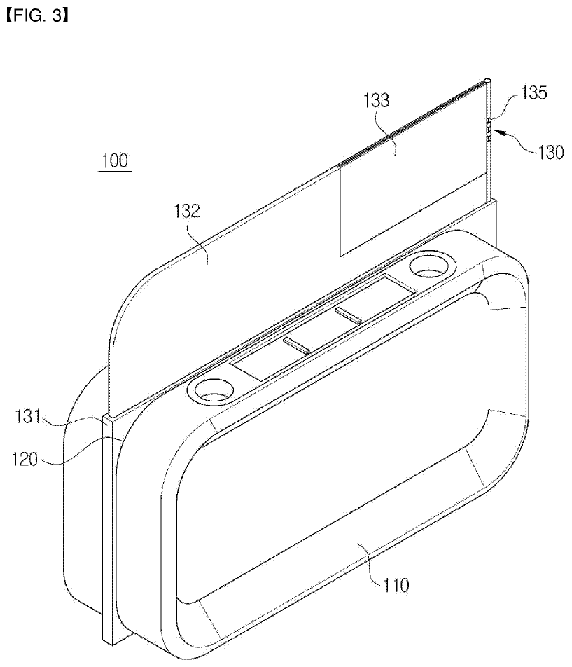

The partition 132 may be in a shape of a plate to partition the spaces where the seats 10 are positioned. When the partition 132 is lifted from the module box 13 and unfolded to partition the spaces of the seats 10, the partition 132 may give comfortability to passengers seated on the seats 10 (see FIG. 3). A pocket portion 132a which the table 133 and the display 134 which will be described below are folded and rested on may be depressed from the partition 132. A shape of the pocket portion 132a may correspond to a shape of the table 133 which will be described below, and when the table 133 is folded into the pocket portion 132a, an outer surface of the table 133 may be coplanar with an outer surface of the partition 132 without any step.

A guide portion (not shown) may be provided between the module box 131 and the partition 132 to smoothly and stably lift the partition 132. The guide portion may include a guide rail extending in the up-down direction on an inner surface of the module box 131, and a roller or a guide protrusion provided on one surface of the partition 132 and moving along the guide rail.

The table 133 may be rotatably connected to a front end of the partition 132, and the display 134 for providing visual information or content to passengers seated on the seats 10 may be provided on the rear surface of the table 133. A pair of tables 133 and a pair of displays 134 may be provided at the front end of the partition 132 for the respective passengers seated on the pair of seats 10. The table 133 and the display 134 may be rotatably connected to the partition 132 and supported with respect to the partition 132 by the hinge connection portion 135, and a rotation shaft 135a of the hinge connection portion 135 may extend in the up-down direction. In the case in which a pair of tables 133 are provided, a pair of hinge connection portions 135 may be provided to independently rotate the respective tables 133 with respect to the partition 132. By rotating and unfolding the table 133 and the display 134 by the hinge connection portion 135, the display 134 may be positioned in front of a passenger seated on the seat 10 (see FIG. 4).

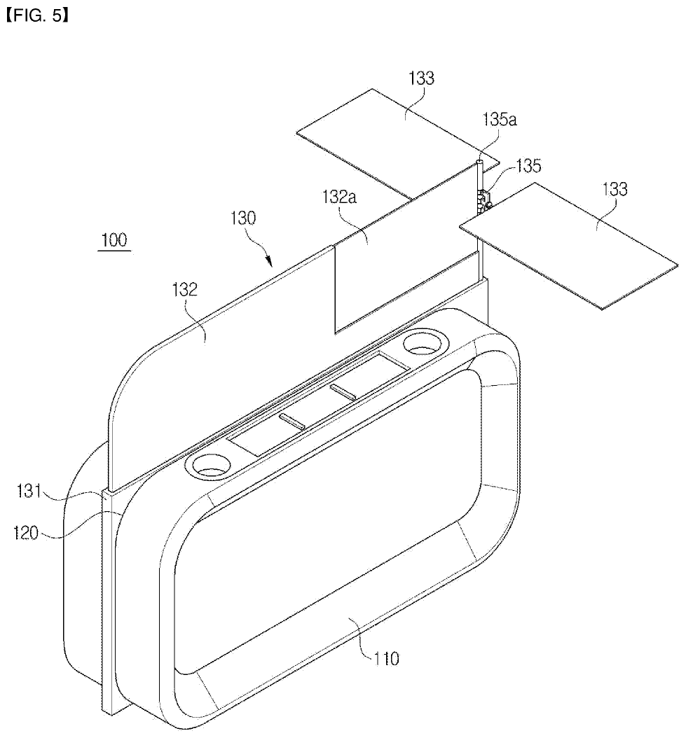

The table 133 and the display 134 may be rotatably connected to the hinge connection portion 135 and supported with respect to the hinge connection portion 135 by the rotation connection portion 136. More specifically, the rotation connection portion 136 may be positioned between the table 133 and the display 134 and the hinge connection portion 135 such that a rotation shaft of the rotation connection portion 136 extends in a horizontal direction or the rotation connection portion 136 includes, as shown in FIG. 6, a ball joint 136a to rotate the table 133 and the display 134 in various directions and to various angles with respect to the hinge connection portion 135. By rotating the table 133 and the display 134 by the rotation connection portion 136 such that the table 133 faces up, a passenger seated on the seat 10 may use the table 133 to put his/her things on (see FIG. 5).

The console device for vehicle according to an embodiment may improve product competitiveness of the vehicle by providing various convenient equipment to passengers.

The console device for vehicle according to an embodiment may improve a passenger's convenience and residential comfort.

The console device for vehicle according to an embodiment may lower manufacturing cost and improve productivity with a simple structure.

The console device for vehicle according to an embodiment may make better use of an indoor space.

The console device for vehicle may easily store and unfold various convenient equipment.

What is claimed is:

1. A console device for vehicle comprising:
a main body provided to one side of a seat;
an accommodating groove depressed from the main body in an up-down direction, wherein an upper portion of the accommodating groove opens; and
a convenient module configured to be liftable from the accommodating groove,
wherein the convenient module comprises:
a partition configured to partition a space where the seat is positioned;
at least one table connected to a front end of the partition;
a display provided on a rear surface of the table; and
a hinge connection portion rotatably supporting the table and the display with respect to the partition.

2. The console device for vehicle of claim 1, wherein the convenient module further includes a rotation connection portion rotatably supporting the table and the display with respect to the hinge connection portion.

3. The console device for vehicle of claim 2, wherein
a rotation shaft of the hinge connection portion extends in the up-down direction, and
a rotation shaft of the rotation connection portion extends in a horizontal direction.

4. The console device for vehicle of claim 2, wherein a rotation shaft of the hinge connection portion extends in the up-down direction, and
the rotation connection portion includes a ball joint.

5. The console device for vehicle of claim 2, wherein the partition includes a pocket portion depressed from the partition, and the table and the display are rested on the pocket portion when being folded.

6. The console device for vehicle of claim 1, wherein the convenient module further includes a module box accommodating a component therein, wherein an upper portion of the module box includes an opening, the module box being configured to be put in or taken out of the accommodating groove.

7. The console device for vehicle of claim 6, wherein the convenient module further includes a door configured to open or close the opening.

8. The console device for vehicle of claim 7, wherein the door is rotatable with respect to the module box, and
a rotation shaft of the door extends in a front-rear direction.

9. The console device for vehicle of claim 8, wherein the rotation shaft of the door is elastically supported in a direction of closing the opening.

10. The console device for vehicle of claim 2, wherein a pair of tables and a pair of displays are provided, and a pair of hinge connection portions are provided to rotatably support the pair of tables and the pair of displays independently with respect to the partition.

11. The console device for vehicle of claim 1, wherein the accommodating groove is formed in the main body and extends in a front-rear direction.
